(19) United States
(12) Patent Application Publication
(10) Pub. No.: US 2017/0098114 A1
(43) Pub. Date: Apr. 6, 2017

(54) METHOD AND SYSTEM FOR PROCESSING INPUT FINGERPRINT INFORMATION, AND MOBILE TERMINAL THEREOF

(71) Applicant: Shenzhen Huiding Technology Co., Ltd., Shenzhen (CN)

(72) Inventor: Chiu-po HUNG, Shenzhen (CN)

(21) Appl. No.: 15/382,652

(22) Filed: Dec. 17, 2016

Related U.S. Application Data
(63) Continuation of application No. PCT/CN2015/073825, filed on Mar. 6, 2015.

(30) Foreign Application Priority Data
Nov. 7, 2014 (CN) 201410623900.1

(51) Int. Cl. G06K 9/00; G06F 17/30

(52) U.S. Cl. CPC G06K 9/00087; G06K 9/00013; G06F 17/30259; H04L 63/0861

(57) ABSTRACT

The present disclosure discloses a method and a system for processing input fingerprint information, and a mobile terminal thereof. The method includes the following steps: a fingerprint information identification step: when scanning that fingerprint information is input, identifying whether a fingerprint template matching with the input fingerprint information is presented in a fingerprint database, the fingerprint database includes a plurality of pre-registered fingerprint templates; and an operation execution step: upon identifying that a fingerprint template matching with the fingerprint information is presented in the fingerprint database, performing a predetermined associated operation according to a combination of the fingerprint information and a holding manner of a current mobile terminal.

### CROSS-REFERENCE TO RELATED APPLICATIONS

The present application is a continuation of international application No. PCT/CN2015/073825, filed on Mar. 6, 2015, which claims priority to Chinese Patent Application No. CN201410623900.1, filed on Nov. 7, 2014, both of which are hereby incorporated by reference in its entireties.

### TECHNICAL FIELD

The present disclosure pertains to the field of fingerprint identification, and in particularly, to a method and a system for processing input fingerprint information, and a mobile terminal thereof.

### BACKGROUND

In modern life, people rely more and more on mobile phones, and are placing higher and higher requirements on convenience, responsiveness and security of the mobile phones.

For example, the mobile phones are currently provided with various applications (APPs), and some APPs are higher frequently used, for example, the photographing APP. Sometimes, we need to quickly start the photographing APP from a standby screen off state to take photos. In this case, a high requirement is placed on the convenience and responsiveness of startup of the photographing APP. Therefore, if such applications are started more quickly than usual, a better experience may be brought to users. In recent years, iPhone sets up the upsurge in the fingerprint identification technology in mobile terminals. At present, many mobile phone manufacturers are starting their deployment of products supporting fingerprint identification technology.

With the increasing requirements of users, the fingerprint technology is not constrained to such aspects as unlocking and the like. How to attain a more convenient, quicker and funny use experience is an innovation development trend for the fingerprint technology. In addition, modern people highly concerned about their privacies, and when the mobile phones have to be lent to others, some applications which are not desired to be used by others in the mobile phones may bring about unnecessary troubles or embarrassments.

Therefore, mobile phones that are improved in terms of convenience, responsiveness, security, privacy protection and the like would be more populated by consumers.

### SUMMARY

A method for processing input fingerprint information, wherein the method includes the following steps:

Identifying, when scanning that fingerprint information is input, whether a fingerprint template matching with the input fingerprint information is presented in a fingerprint database, wherein the fingerprint database comprises a plurality of pre-registered fingerprint templates; and

Performing, upon identifying that a fingerprint template matching with the fingerprint information is presented in the fingerprint database, a predetermined associated operation according to a combination of the fingerprint information and a holding manner of a current mobile terminal.

### BRIEF DESCRIPTION OF THE DRAWINGS

FIG. 1 is a flowchart of a method for processing input fingerprint information according to an embodiment of the present disclosure; and

FIG. 2 is a structural principle diagram of a system for processing input fingerprint information according to an embodiment of the present disclosure.

### DETAILED DESCRIPTION

In order to make the objectives, technical solutions, and advantages of the present disclosure clearer, the present disclosure is further described in detail by reference to the embodiments and the drawings. It should be understood that the embodiments described here are only exemplary ones for illustrating the present disclosure, and are not intended to limit the present disclosure.

In the present disclosure, a plurality of fingerprints is pre-registered as fingerprint templates, and then a combination of each fingerprint template and a holding manner of a mobile terminal is set to be correlated with a predetermined associated operation. The predetermined associated operation includes, but not limited to, perform an application, a function, an interface, a style and a mode.

After scanning that a user inputs fingerprint information, the input fingerprint information is matched with the fingerprint templates. If a matched fingerprint template is present, the predetermined associated operation is performed according to the combination of the fingerprint information and the holding manner of the mobile terminal. Specifically, the technical solution according to the present disclosure may be applicable to mobile terminals supporting the fingerprint identification function, such as mobile phones, PDAs, iPads and the like.

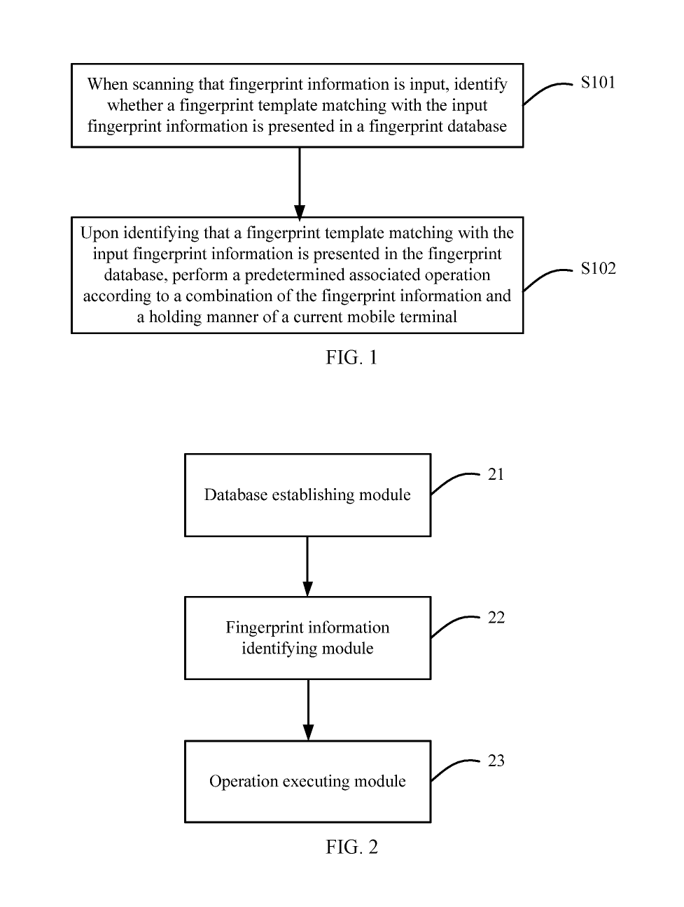

FIG. 1 is an implementation flowchart of a method for logging into a terminal based on fingerprint identification in a standby state according to an embodiment of the present disclosure, which is described in detail hereinafter.

Step S101: this step mainly identifies fingerprint information. Specifically, when scanning that fingerprint information is input, it identifies whether a fingerprint template matching with the input fingerprint information is presented in a fingerprint database of the mobile terminal.

In the embodiment of the present disclosure, a user needs to pre-register a plurality of fingerprint templates, each fingerprint template includes conventional fingerprint information; and moreover, an execution matter correlated with a combination of each fingerprint template and a holding manner of a mobile terminal is set. This step may be performed in one of a screen on state, a standby screen off state, an unlocked state, and a locked state of the mobile terminal.

Step S102: This step mainly performs a specific operation. Specifically, upon identifying that a fingerprint template matching with the input fingerprint information is presented in the fingerprint database, a predetermined associated operation is performed according to a combination of the fingerprint information and the holding manner of the mobile terminal.

The holding manner of the mobile terminal may be detected by using an acceleration sensor or a gravity sensor of the mobile terminal, and the predetermined associated operation may be performed in combination with the fingerprint information. For example, a registered fingerprint 1 corresponding to a finger 1 combined with a lateral holding manner (i.e., a landscape manner) of the mobile phone is correlated with a camera operation.

As described above, step S101 may be performed in the screen on state or the standby screen off state of the mobile terminal; and when this step is performed in the standby screen off state, in step S102, the screen needs to be lit up first and then the associated operation is performed.

Hereinafter, the specific principle of step S102 is described by taking an APP, a working mode application, a dialup application, an operating system, or the system subject application as an example.

With respect to the APP, upon identifying that a fingerprint template matching with the input fingerprint information is presented in the fingerprint database, a predetermined associated operation is performed according to a combination of the fingerprint information and a holding manner of a mobile terminal. Even for a same fingerprint of the finger, different application can be set corresponding to different holding manners of the mobile terminal.

Upon a condition that a mobile phone is holding laterally and the mobile phone is in the screen off state, after a registered finger 1 touches the fingerprint sensor, the screen is directly lit on and then a photographing software is opened. A browser may be directly launched after a finger 2 touches the fingerprint sensor. It should be understood that this embodiment is not limited to the camera function. In one manner, the mobile terminal may enter different standby states, for example, a mute state, a vibration state and the like, or the mobile terminal may enter different operating systems according to the combination results, or enter different system interfaces, for example, a setting menu or a dialup panel.

When the mobile phone is in the screen on state, the photographing software is directly opened after the registered finger 1 touches the fingerprint sensor. A browser may be directly launched after the finger 2 touches the fingerprint sensor. Likewise, this embodiment is not limited to the camera function.

With respect to the dialup application, upon identifying that a matched fingerprint template is presented in the fingerprint database, a telephone number corresponding to a combination of the fingerprint template and the holding manner of the mobile terminal is dialed. For example, the touch identification of the finger 1 in the lateral holding manner corresponds to a telephone number 1; and the touch identification of the finger 2 in the lateral holding state corresponds to a telephone number 2. Where a call needs to be made, the user may touch the fingerprint sensor by using a corresponding finger in the lateral holding manner, and upon identification by the system, the correspondingly telephone number may be directly dialed through. Herein, the telephone number may be dialed when necessary, which is not limited to the scenario of whether the screen is off or on.

With respect to the operating system application, upon identifying that a matched fingerprint template is presented in the fingerprint database, an operating system or a ROM associated with the identified fingerprint template is started.

Some mobile phones are installed with different operating systems (or ROMs), and the user may set different fingerprints and holding manners to correspond to different operating systems (or ROMs). For example, the touch on the fingerprint sensor by the finger 1 in the lateral holding manner corresponds to a system 1 (or a ROM 1); and the touch on the fingerprint sensor by the finger 2 in the lateral holding manner corresponds to a system 2 (or a ROM 2). Alternatively, the touch on the fingerprint sensor by the finger 1 in the lateral holding manner corresponds to a system 1 (or a ROM 1); and the touch on the fingerprint sensor by the finger 1 in a lengthways holding manner (i.e., a portrait manner) corresponds to a system 2 (or a ROM 1). When the operating system (or the ROM) needs to be switched or an operating system (or a ROM) needs to be loaded, the user may select different operating systems (or ROMs) to start by using a different registered finger to touch the fingerprint sensor and using different holding manner. The above described operating system switching may be performed when necessary, which is not limited to the scenario of whether the screen of the device is off or on.

With respect to the system subject application, upon identifying that a matched fingerprint template is presented in the fingerprint database, the associated system subject information is loaded according to a combination of the fingerprint information and the holding manner of the mobile terminal.

Some mobile phones are provided with different system subjects (different interface styles, background styles and the like). Further, the user may correlate different combination of fingerprint touches and holding manners of mobile terminal with different system subjects (interface styles, background styles and the like). For example, a touch on the fingerprint sensor by the finger 1 in a lateral holding state corresponds to a system subject 1 (or an interface style, a background style and the like), and a touch on the fingerprint sensor by the finger 1 in a lengthways holding state corresponds to a system subject 2 (or an interface style, a background style and the like). When the system subject (or the interface style, the background style and the like) needs to be switched or a system subject (or an interface style, a background style and the like) needs to be loaded, by using a finger to touch the fingerprint sensor, the mobile terminal may select different system subjects (or interface styles, background styles and the like) according to the holding manner of the mobile terminal. Likewise, the system subject is switched anytime, which is not limited to the scenario of whether the screen of the device is off or on.

FIG. 2 is a structural principle diagram of a system for processing input fingerprint information according to an embodiment of the present disclosure. For ease of description, only the portions relevant to the present disclosure are illustrated. The system for processing input fingerprint information may be a software unit, a hardware unit or a software-hard hybrid unit that is built in a mobile terminal supporting the fingerprint identification function.

Referring to FIG. 2, the system for processing input fingerprint information includes a database establishing module 21, a fingerprint information identifying module 22 and an operating executing module 23.

The fingerprint database establishing module is configured to register fingerprint templates in a fingerprint database, and set a predetermined associated operation correlated with a combination of each fingerprint template and a holding manner of a mobile terminal;

the fingerprint information identifying module 22 is configured to, when scanning that fingerprint information is input, identifying whether a fingerprint template matching with the input fingerprint information is presented in the fingerprint database; and

the operation executing module 23 is configured to, upon identifying that a fingerprint template matching with the input fingerprint information is presented in the fingerprint database, perform the predetermined associated operation according to a combination of the fingerprint information and the holding manner of the mobile terminal.

As described above, the fingerprint information identifying module 21 may perform fingerprint identifying operation in one of a screen on state, a standby screen off state, an unlocked state, and a locked state; and when the operation executing module 23 performs the operation in the standby screen off state, the operation executing module 23 lights up a screen first, and then performs the predetermined associated operation according to the combination of the fingerprint information and the holding manner of the mobile terminal.

When the operation associated with the fingerprint template is an APP, the operation executing module 23 is configured to, upon identifying that a fingerprint template matching with the input fingerprint information is presented in the fingerprint database, start the associated APP according to the combination of the fingerprint information and the holding manner of the mobile terminal.

When the operation associated with the fingerprint template is a dialup application, the operation executing module 23 is configured to, upon identifying that a fingerprint template matching with the input fingerprint information is presented in the fingerprint database, dial a corresponding telephone number according to the combination of the fingerprint information and the holding manner of the mobile terminal.

When the operation associated with the fingerprint template is an operating system, the operation executing module 23 is configured to, upon identifying that a fingerprint template matching with the input fingerprint information is presented in the fingerprint database, start a corresponding operating system or ROM according to the combination of the fingerprint information and the holding manner of the mobile terminal.

When the operation associated with the fingerprint template is a system subject application, the operation executing module 23 is configured to, upon identifying that a fingerprint template matching with the input fingerprint information is presented in the fingerprint database, load the associated system subject information according to the combination of the fingerprint information and the holding manner of the mobile terminal.

In conclusion, in the present disclosure, a plurality of operation results are proposed according to the actual usage scenario of the user based on the fingerprint identification, thereby improving the convenience, quickness and security performance of the mobile phone.

It is understandable to those skilled in the art that all or partial steps of the method described in the above embodiments can be implemented by controlling relevant hardware by programs. The programs may be stored in a computer readable storage medium. The storage medium may be a read only memory (ROM), random access memory (RAM), a magnetic disk or a compact disc read-only memory (CD-ROM).

The above descriptions are merely preferred embodiments of the present disclosure, but not intended to limit the present disclosure. Any modification, equivalent replacement, and improvement made without departing from the spirit and principle of the present disclosure shall fall within the protection scope of the present disclosure.

### INDUSTRIAL APPLICABILITY

In the present disclosure, a plurality of fingerprints are pre-registered as fingerprint templates, and a predetermined associated operation is performed according to a combination result of the fingerprint information and a holding manner of a mobile terminal, for example, an application, a function, an interface, a style and a mode may be performed. In this way, no matter in a screen on state or a screen off state, the associated operation may all be started, such that a user may experience more convenient and quicker services. In the present disclosure, since various application operations are all associated with specific fingerprint information, the privacy is better protected.

What is claimed is:

1. A method for processing input fingerprint information in a mobile terminal, comprising:
identifying, when scanning that fingerprint information is input, whether a fingerprint template matching with the input fingerprint information is presented in a fingerprint database, wherein the fingerprint database comprises a plurality of pre-registered fingerprint templates; and
performing, upon identifying that a fingerprint template matching with the fingerprint information is presented in the fingerprint database, a predetermined associated operation according to a combination of the fingerprint information and a holding manner of the mobile terminal.

2. The method for processing input fingerprint information according to claim 1, wherein the fingerprint identification step is performed in one of a screen on state, a standby screen off state, an unlocked state, and a locked state.

3. The method for processing input fingerprint information according to claim 2, wherein when the fingerprint identification step is performed in a standby screen off state, a screen is lit up first, and then the predetermined associated operation is performed according to the combination of the fingerprint information and the holding manner of the mobile terminal.

4. The method for processing fingerprint information according to claim 3, wherein the predetermined associated operation comprises performing an application, a function, an interface, a style and a mode.

5. The method for processing fingerprint information according to claim 1, further comprising:
pre-registering a plurality of fingerprint templates in the fingerprint database, wherein each of the plurality of fingerprint templates comprises registered fingerprint information; and
correlating, each of a plurality of predetermined associated operations with a combination of one of the plurality of fingerprint templates and a holding manner of the mobile terminal.

6. The method for processing fingerprint information according to claim 1, wherein the holding manner of the mobile terminal is detected by an acceleration sensor or a gravity sensor of the mobile terminal.

7. The method for processing fingerprint information according to claim 6, wherein the holding manner comprises a landscape manner or a portrait manner.

8. The method for processing fingerprint information according to claim 7, wherein different holding manners of a same registered fingerprint are correlated with different operations.

9. A system for processing input fingerprint information, comprising:
a fingerprint database establishing module, configured to register a plurality of fingerprint templates in a fingerprint database, and set a predetermined associated operation correlated with each of the plurality of fingerprint templates;
a fingerprint information identifying module, configured to, when scanning that fingerprint information is input, identify whether a fingerprint template matching with the fingerprint information is presented in the fingerprint database; and
an operation executing module, configured to, upon identifying that a fingerprint template matching with the fingerprint information is presented in the fingerprint database, perform the predetermined associated operation according to a combination of the fingerprint information and a holding manner of a mobile terminal.

10. The system for processing input fingerprint information according to claim 9, wherein the fingerprint identifying module performs the operation in one of a screen on state, a standby screen off state, an unlocked state, and a locked state.

11. The system for processing input fingerprint information according to claim 10, wherein when the fingerprint information identifying module performs fingerprint identifying operation in the standby screen off state, the operation executing module lights up a screen first, and then performs the predetermined associated operation according to the combination of the fingerprint information and the holding manner of the mobile terminal.

12. The system for processing fingerprint information according to claim 11, wherein the predetermined associated operation comprises performing an application, a function, an interface, a style and a mode.

13. The system for processing fingerprint information according to claim 9, wherein each fingerprint template comprises registered fingerprint information; and the predetermined associated operation is correlated with a combination of each of the plurality of fingerprint templates and a holding manner of the mobile terminal.

14. The system for processing fingerprint information according to claim 9, wherein the holding manner of the current mobile terminal is detected by an acceleration sensor or a gravity sensor of the mobile terminal.

15. The system for processing fingerprint information according to claim 14, wherein the holding manner comprises a landscape manner or a portrait manner.

16. The system for processing fingerprint information according to claim 15, wherein different holding manners of a same registered fingerprint are correlated with different operations.

17. A mobile terminal, comprising a system for processing input fingerprint information, the system comprises:
a fingerprint database establishing module, configured to register a plurality of fingerprint templates in a fingerprint database, and correlate a combination of each of the plurality of fingerprint templates and a terminal holding manner with a predetermined operation;
a fingerprint information identifying module, configured to identify, when scanning that fingerprint information is input, whether a fingerprint template matching with the fingerprint information is presented in the fingerprint database; and
an operation executing module, configured to perform, upon identifying that a fingerprint template matching with the fingerprint information is presented in the fingerprint database, the predetermined operation according to the fingerprint template and a current holding manner of the mobile terminal.

18. The mobile terminal according to claim 17, wherein the current holding manner of the mobile terminal is detected by an acceleration sensor or a gravity sensor of the mobile terminal.

19. The mobile terminal according to claim 17, wherein the holding manner comprises a landscape manner or a portrait manner.

20. The mobile terminal according to claim 18, wherein different holding manners of a same registered fingerprint are correlated with different operations.
